(19) United States
(12) Patent Application Publication
(10) Pub. No.: US 2026/0067178 A1
(43) Pub. Date: Mar. 5, 2026

(54) COMMUNICATION CONTROL METHOD AND USER EQUIPMENT

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/384,835

(22) Filed: Nov. 10, 2025

Related U.S. Application Data
(63) Continuation of application No. PCT/JP2024/017462, filed on May 10, 2024.

(30) Foreign Application Priority Data
May 11, 2023 (JP) 2023-078830

(51) Int. Cl. H04L 41/16; H04L 41/14

(52) U.S. Cl. CPC H04L 41/16; H04L 41/145

(57) ABSTRACT

A communication control method according to an aspect is a communication control method in a mobile communication system. The communication control method includes transmitting, by a model management entity, timing information indicating an execution timing of a predetermined operation to a model training entity. Further, the communication control method includes executing, by the model training entity, the predetermined operation at the execution timing. Here, the predetermined operation is at least one selected from the group consisting of transmitting model training history information indicating a history of model training performed on a first AI/ML model to the model management entity, transmitting a second AI/ML model after model training has been performed on the first AI/ML model to the model management entity, and updating model identification information identifying the second AI/ML model.

### RELATED APPLICATIONS

The present application is a continuation based on PCT Application No. PCT/JP2024/017462, filed on May 10, 2024, which claims the benefit of Japanese Patent Application No. 2023-078830 filed on May 11, 2023. The content of which is incorporated by reference herein in their entirety.

### TECHNICAL FIELD

The present disclosure relates to a communication control method and a user equipment.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

A communication control method according to a first aspect is a communication control method in a mobile communication system. The communication control method includes transmitting, by a model management entity, timing information indicating an execution timing of a predetermined operation to a model training entity. Further, the communication control method includes executing, by the model training entity, the predetermined operation at the execution timing. Here, the predetermined operation is at least one selected from the group consisting of transmitting model training history information indicating a history of model training performed on a first AI/ML model to the model management entity, transmitting a second AI/ML model after model training has been performed on the first AI/ML model to the model management entity, and updating model identification information identifying the second AI/ML model.

A user equipment according to a second aspect includes a receiver configured to receive timing information transmitted from a model management entity and indicating an execution timing of a predetermined operation. Further, the user equipment includes a controller configured to execute the predetermined operation at the execution timing. Here, the predetermined operation is at least one selected from the group consisting of transmitting model training history information indicating a history of model training performed on a first AI/ML model to the model management entity, transmitting a second AI/ML model after model training has been performed on the first AI/ML model to the model management entity, and updating model identification information identifying the second AI/ML model.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIGS. 9A and 9B are diagrams illustrating an example of reducing CSI-RSs according to the first embodiment.

FIG. 10 is a diagram illustrating an operation example according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an arrangement example of functional blocks of the AI/ML technology according to the first embodiment.

FIG. 14 is a diagram illustrating an operation example according to the first embodiment.

FIG. 15 is a diagram illustrating an example of a configuration message according to the first embodiment.

FIG. 16 is a diagram illustrating a configuration example of a mobile communication system 1 according to the first embodiment.

FIG. 17 is a diagram illustrating an operation example according to the first embodiment.

FIG. 18 is a diagram illustrating an operation example according to the first embodiment.

FIG. 19 is a diagram illustrating an operation example according to a second embodiment.

FIG. 20 is a diagram illustrating an operation example according to a third embodiment.

### DESCRIPTION OF EMBODIMENTS

The present disclosure aims to enhance communication efficiency.

### First Embodiment

A mobile communication system according to a first embodiment will be described with reference to the drawings. In the description of the drawings, the same or similar parts are denoted by the same or similar reference signs.

### Configuration of Mobile Communication System

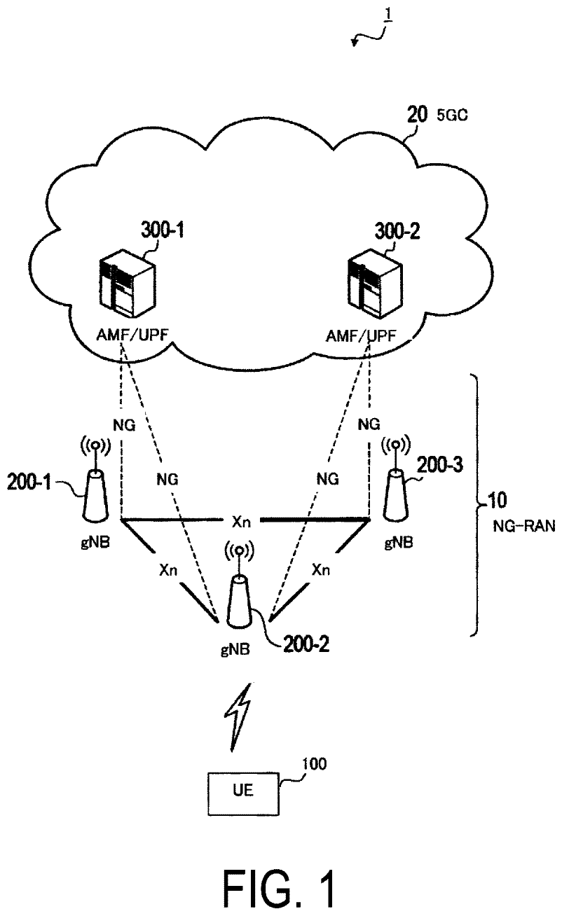

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

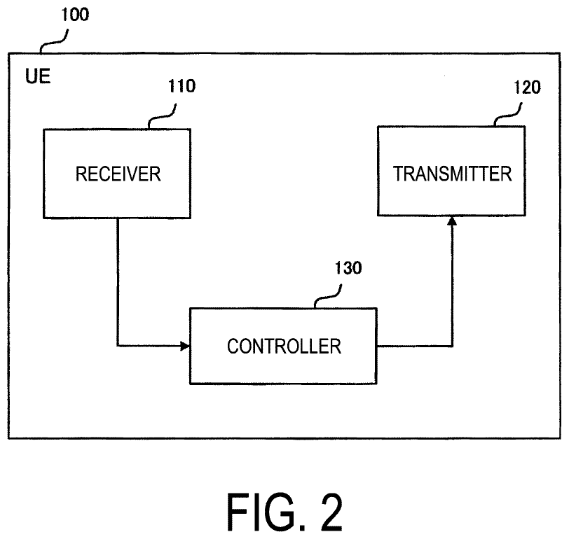

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

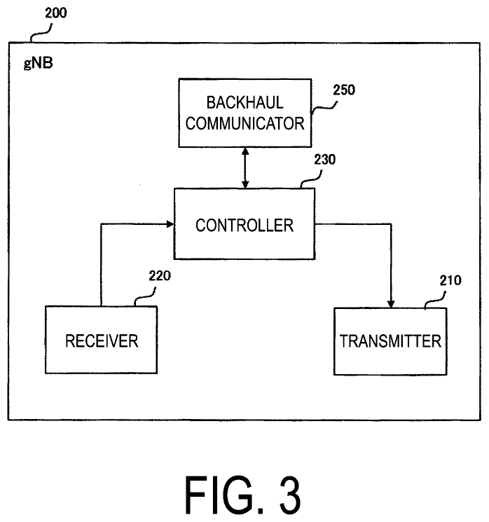

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

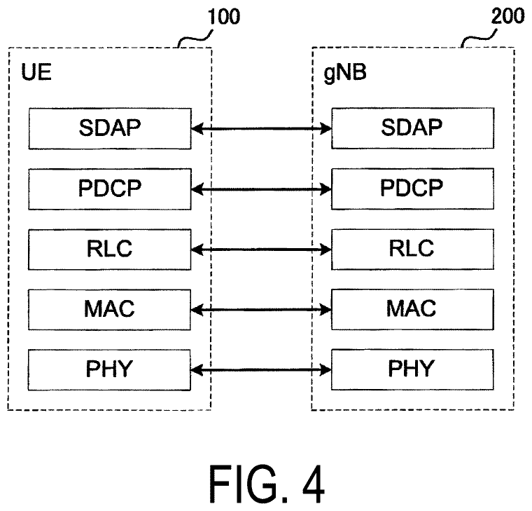

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. Cyclic redundancy code (CRC) parity bits scrambled by the RNTI are added to the DCI transmitted from the gNB 200.

In NR, the UE 100 can use a bandwidth narrower than a system bandwidth (i.e., a cell bandwidth). The gNB 200 configures a bandwidth portion (BWP) consisting of consecutive

Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the receiving side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

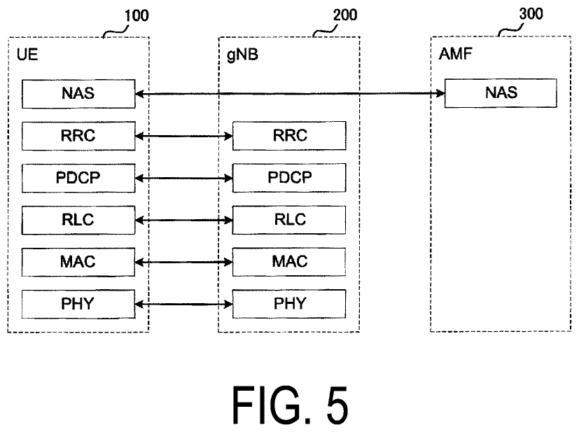

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer and the like other than the protocol of the radio interface. A layer lower than the NAS is referred to as an Access Stratum (AS).

### AI/ML Technology

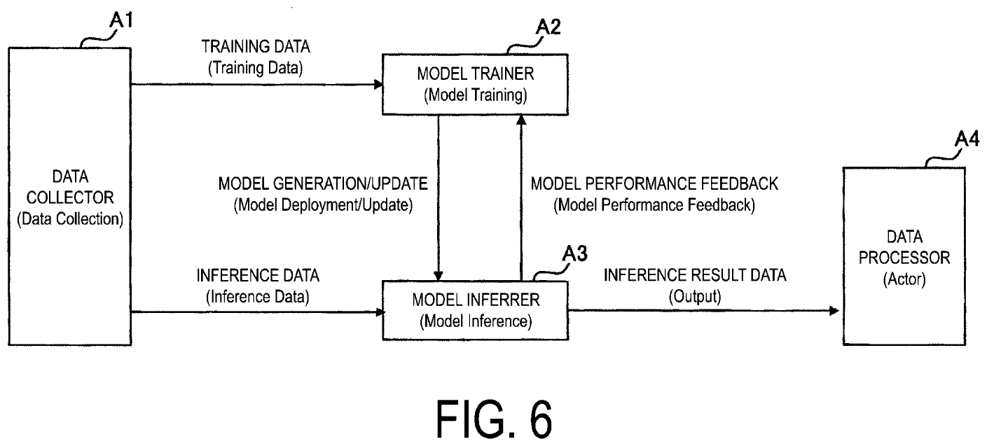

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, the “model” and the “AI/ML model” may be used interchangeably.

The model trainer A2 performs model training. Specifically, the model trainer A2 optimizes parameters of the training model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although the supervised learning will be described hereinafter, unsupervised learning may be applied as the machine learning. The reinforcement learning may be applied as the machine learning. In this way, the process of training an AI/ML model (by training the relationship between input and output) in a data-driven manner and acquiring a trained AI/ML model is called, for example, AI/ML model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

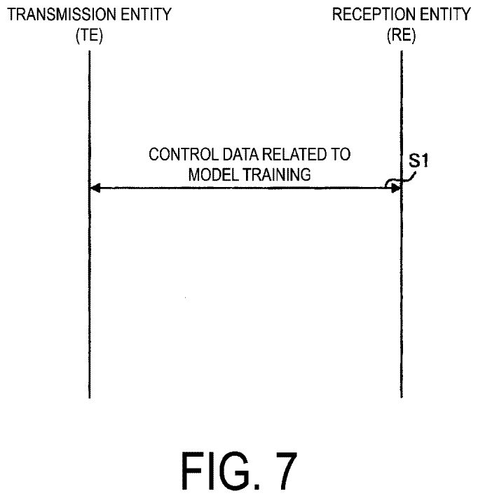

FIG. 7 is a diagram illustrating an operation example in the AI/ML technology according to the first embodiment.

A transmission entity TE is, for example, an entity in which machine learning is performed. The transmission entity TE may derive a trained model by performing machine learning. Then, the transmission entity TE uses the trained model to generate inference result data as an inference result. The transmission entity TE transmits the inference result data to a reception entity RE.

The reception entity RE is, for example, an entity in which no machine learning is performed. The reception entity RE receives the inference result data transmitted from the transmission entity TE. The reception entity RE performs various processing operations by using the inference result data.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE

As illustrated in FIG. 7, in step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The control data may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement” Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

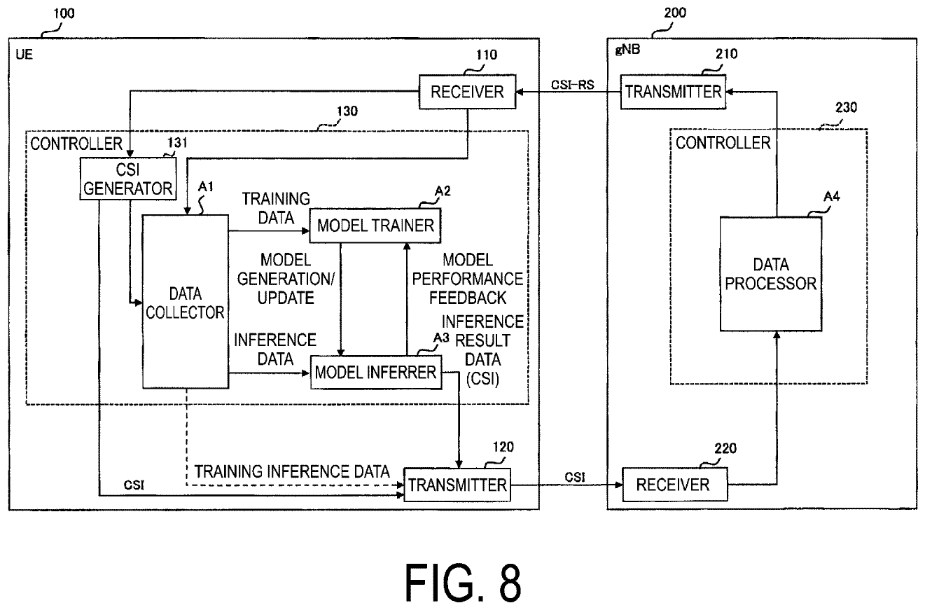

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

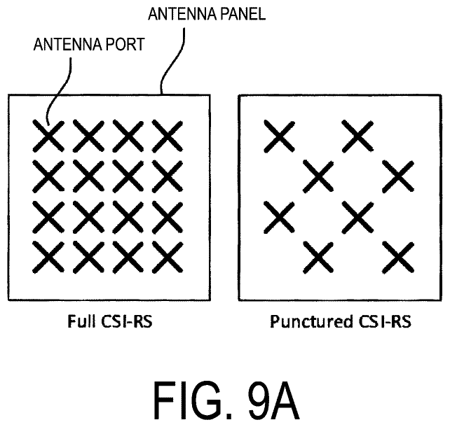

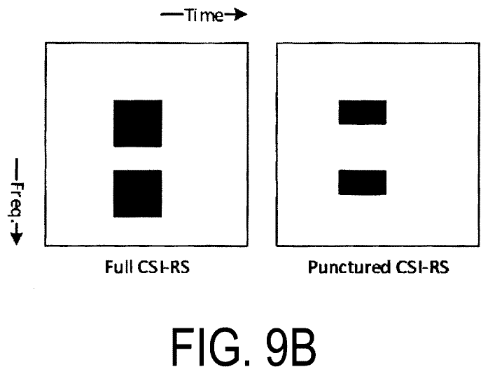

FIGS. 9A and 9B are diagrams illustrating an example of reducing CSI-RSs according to the first embodiment.

FIG. 9A illustrates an example in which the CSI-RSs are reduced by reducing the number of antenna ports for transmitting the CSI-RSs. For example, the gNB 200 may perform the following processing. In other words, the gNB 200 transmits the CSI-RS from all antenna ports of the antenna panel in a mode in which the UE 100 performs the model training (which may hereinafter be referred to as a “training mode”). On the other hand, in the mode in which the UE 100 performs model inference (which may hereinafter be referred to as an “inference mode”), the gNB 200 reduces the number of antenna ports for transmitting the CSI-RS, and transmits the CSI-RS from half the antenna ports of the antenna panel. This enables reduced overhead and improved utilization efficiency for the antenna ports, and allows a reduction effect for power consumption to be produced. Note that the antenna port is an example of the resource.

On the other hand, FIG. 9B illustrates an example in which the gNB 200 reduces the number of radio resources used to transmit the CSI-RS, specifically, the number of time-frequency resources. For example, the gNB 200 may perform the following processing. In other words, when the UE 100 is in the training mode, the gNB 200 transmits the CSI-RS by using predetermined time-frequency resources. On the other hand, when the UE 100 is in the inference mode, the gNB 200 transmits the CSI-RS using time-frequency resources the amount of which is smaller than that of the predetermined time-frequency resources. This enables reduced overhead and improved utilization efficiency for the radio resources, and allows a reduction effect for power consumption to be produced.

As illustrated in FIGS. 9A and 9B, the gNB 200 transmits the full CSI-RS using a predetermined amount of first resources, and transmits the partial CSI-RS using second resources that are less than the first resources.

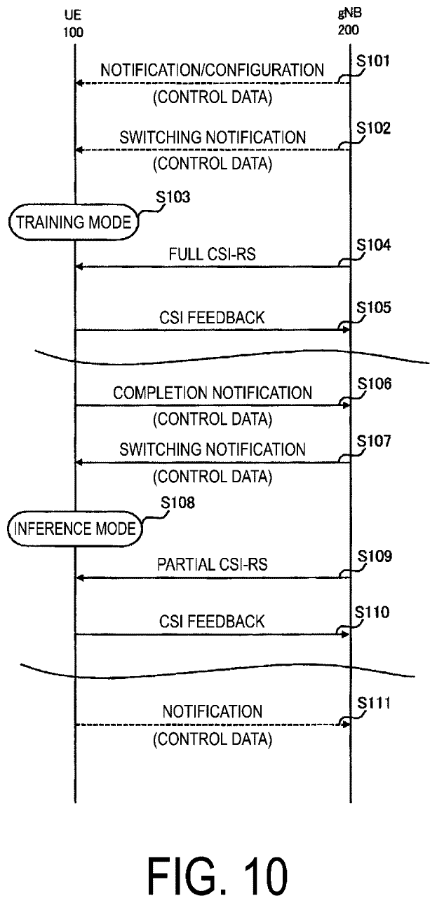

FIG. 10 illustrates an operation example in the “CSI feedback enhancement” according to the first embodiment.

As illustrated in FIG. 10, in step S101, the gNB 200 may notify the UE 100 of or configure for the UE 100, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full

CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 10, the training data is “(full) CSI-RS” and “CSI”, and the inference data is “(partial) CSI-RS”. Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)

What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

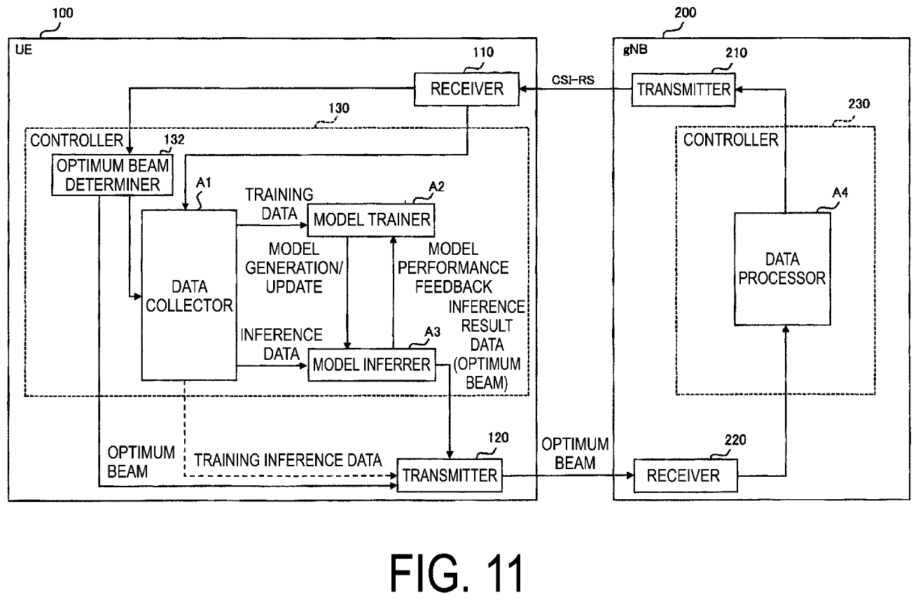

FIG. 11 is a diagram illustrating an arrangement example of the functional blocks in the “beam management”. In the example of the “beam management” illustrated in FIG. 11, the controller 130 of the UE 100 includes the data collector A1, the model trainer A2, and the model inferrer A3. On the other hand, the controller 230 of the gNB 200 includes the data processor A4. In other words, FIG. 11 illustrates an example in which the UE 100 performs model training and model inference. FIG. 11 illustrates the example in which the transmission entity TE is the UE 100 and the reception entity RE is the gNB 200.

As illustrated in FIG. 11, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 10.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)

The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit, to the UE 100 as the control data, the data type information used as a dataset. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

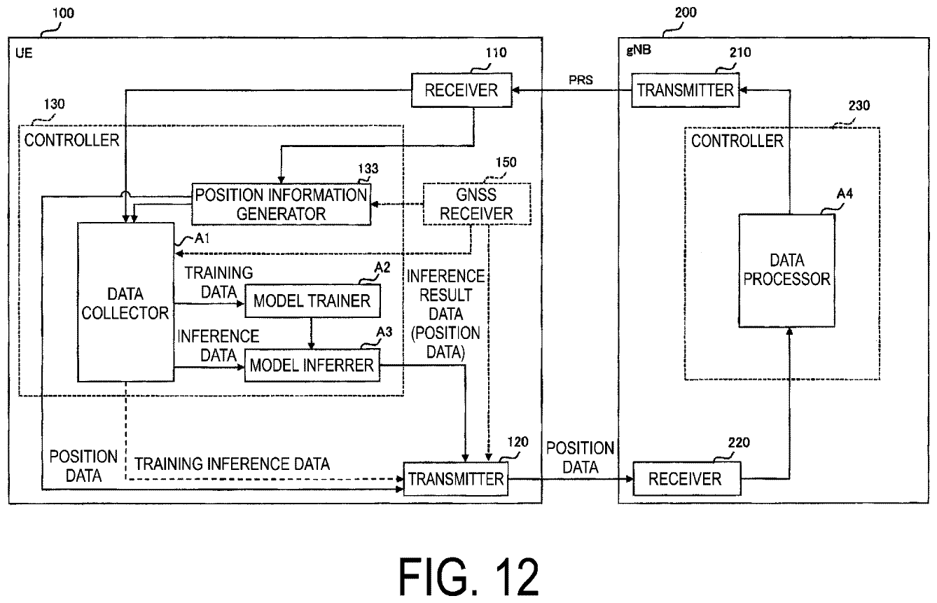

FIG. 12 is a diagram illustrating an arrangement example of the functional blocks in the “positioning accuracy enhancement”. In the example of the “positioning accuracy enhancement” illustrated in FIG. 12, the controller 130 of the UE 100 includes the data collector A1, the model trainer A2, and the model inferrer A3. On the other hand, the controller 230 of the gNB 200 includes the data processor A4. In other words, FIG. 12 illustrates an example in which the UE 100 perform model training and model inference. FIG. 12 illustrates an example in which the transmission entity TE is the UE 100 and the reception entity RE is the gNB 200.

As illustrated in FIG. 12, the UE 100 includes a position information generator 133. The UE 100 may include a Global Navigation Satellite System (GNSS) receiver 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS receiver 150 and generate the position data of the UE 100 based on the GNSS signal.

Note that, as with the full CSI-RS, the gNB 200 transmits the full PRS using a predetermined amount of first resources (for example, all antenna ports as illustrated in FIG. 9A or a predetermined amount of time-frequency resources as illustrated in FIG. 9B). Further, as with the partial CSI-RS, the gNB 200 transmits the partial PRS by using the second resource (for example, half the antenna ports in the antenna panel as illustrated in FIG. 9A, or half the predetermined amount of time-frequency resources as illustrated in FIG. 9B) having the smaller amount of resources than the first resources.

The full GNSS signal may be a GNSS signal temporally continuously received by the GNSS receiver 150. The partial GNSS signal may be a GNSS signal intermittently received by the GNSS receiver 150. In other words, a predetermined amount of first resources may be used for the full GNSS signal, and the second resources the amount of which is smaller than that of the first resources may be used for the partial GNSS signal.

An operation example in the “positioning accuracy enhancement” can be implemented by replacing the “full CSI-RS” with the “full PRS”, the “partial CSI-RS” with the “partial PRS”, and the “CSI feedback” with the “position data” in FIG. 10.

In the training mode (step S103), the position information generator 133 generates the position data of the UE 100 based on the full PRS received from the gNB 200. The position information generator 133 may receive a full GNSS signal received by the GNSS receiver 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS receiver 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (registered trademark), or Bluetooth (registered trademark)
(Z7) Moving speed of the UE 100 (the moving speed may be measured by the GNSS receiver 150. The moving speed may be measured by a speed sensor in the UE 100)

The UE 100 may transmit capability information as the control data to the gNB 200, the capability information indicating which type of input data the UE 100 can handle in the machine learning. The capability information may include any of the information or data (Z1) to (Z7), or may include any of the information or data (Z1) to (Z7) separately from the training data and the inference data. The gNB 200 may transmit, to the UE 100 as the control data, the data type information used as a dataset. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

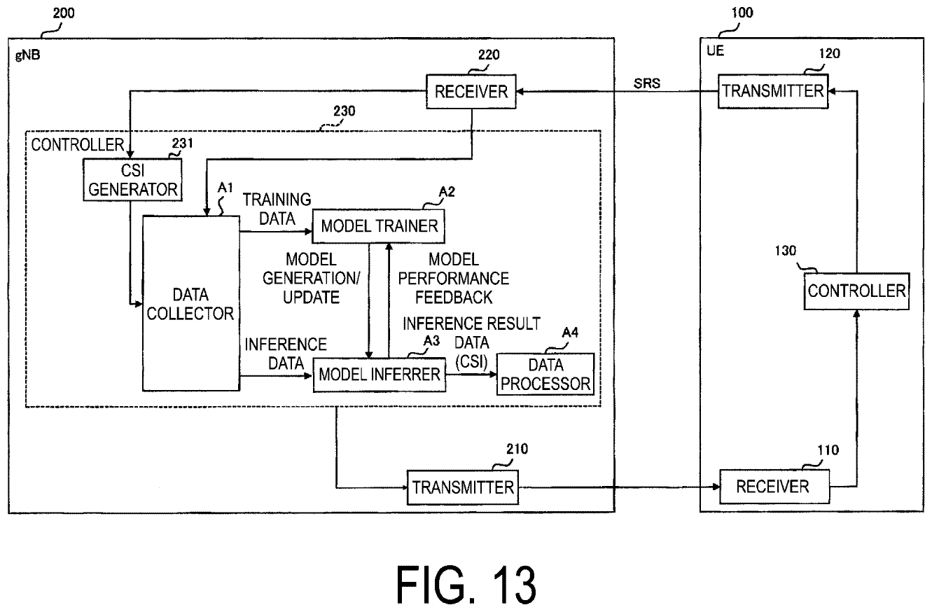

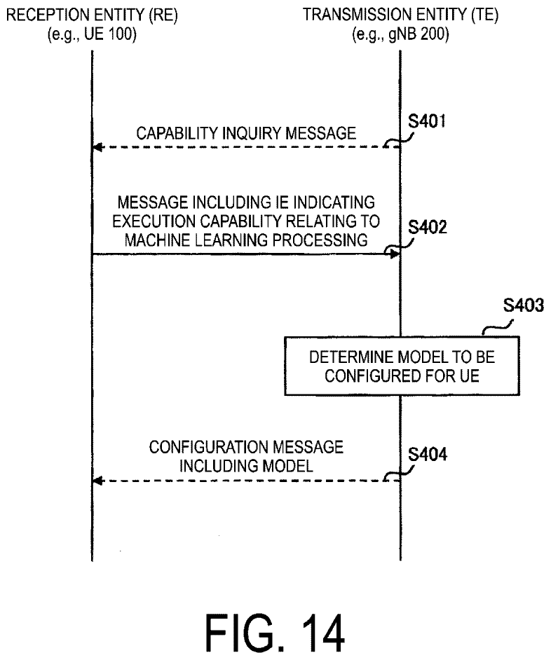

FIG. 13 is a diagram illustrating another arrangement example of the “CSI feedback enhancement” according to the first embodiment. FIG. 13 illustrates an example in which the gNB 200 includes the data collector A1, the model trainer A2, the model inferrer A3, and the data processor A4. In other words, FIG. 14 illustrates an example in which the gNB 200 performs model training and model inference. FIG. 13 illustrates an example in which the transmission entity TE is the gNB 200 and the reception entity RE is the UE 100.

FIG. 13 illustrates an example in which the AI/ML technology is introduced into CSI estimation performed by a gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.6.1) First Operation Pattern Relating to Model Transfer

FIG. 14 is a diagram illustrating an operation example of a first operation pattern relating to model transfer according to the first embodiment. In the example illustrated in FIG. 14, the reception entity RE is mainly described as the UE 100. However, the reception entity RE may be the gNB 200 or AMF 300. In the example illustrated in FIG. 14, the transmission entity TE is mainly described as the gNB 200. However, the transmission entity TE may be the UE 100 or AMF 300.

As illustrated in FIG. 14, in step S401, the gNB 200 transmits, to the UE 100, a capability inquiry message for requesting transmission of the message including the information element (IE) indicating the execution capability relating to the machine learning processing. The UE 100 receives the capability inquiry message. However, the gNB 200 may transmit the capability inquiry message when performing the machine learning processing (when determining to perform the machine learning process).

In step S402, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported. The information element may be an information element indicating the time (response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing. The information element may be an information element indicating the processing capacity of the learning processing.

In step S403, the gNB 200 determines a model to be configured (deployed) for the UE 100 based on the information element included in the message received in step S402.

In step S404, the gNB 200 transmits, to the UE 100, a message including the model determined in step S403. The UE 100 receives the message and performs the machine learning processing (i.e., model training processing and/or model inference processing) using the model included in the message. A specific example of step S404 will be described in a second operation pattern below.

### (1.6.2) Second Operation Pattern Relating to Model Transfer

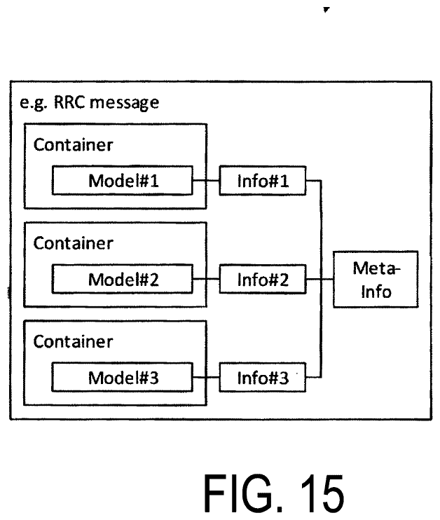

FIG. 15 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 15, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (2) Communication Control Method According to First Embodiment

A communication control method according to the first embodiment will be described.

Here, the following case is assumed. That is, the transmission entity TE performs model inference using a trained model A. Thereafter, the transmission entity TE determines that the inference results of the trained model A deviate compared to the results obtained by a legacy operation (operation that obtains inference results without using an AI/ML model), and performs model training (i.e., re-training) using the trained model A to create a new trained model A′.

In such cases, if a model management entity that manages the AI/ML model can manage a history of model training, it is possible to manage the AI/ML model appropriately. In particular, 3GPP is currently discussing life cycle management (LCM) (hereinafter sometimes referred to as “LCM”) for the AI/ML model. LCM is, for example, managing the life cycle of an AI/ML model, from its generation to its management, operation, and deletion. By appropriately managing the AI/ML model, it is possible to take an appropriate approach to LCM.

However, transmitting a history to the model management entity every time the transmission entity TE performs model training using the trained model A may result in a waste of communication resources. In particular, when the transmission entity TE is the UE 100, transmitting a history to the model management entity every time model training is performed using the trained model A may result in a waste of radio resources.

Therefore, the first embodiment aims to enhance communication efficiency.

Therefore, in the first embodiment, first, the model management entity (e.g., the gNB 200) transmits timing information indicating an execution timing of a predetermined operation to a model training entity (e.g., the UE 100). Second, the model training entity executes a predetermined operation at the execution timing. Here, the predetermined operation is at least one selected from the group consisting of transmitting model training history information indicating a history of model training performed on a first AI/ML model (e.g., the trained model A) to the model management entity, transmitting a second AI/ML model (e.g., the trained model A′) after model training has been performed on the first AI/ML model to the model management entity, and updating model identification information identifying the second AI/ML model.

In this way, in the first embodiment, the model management entity transmits timing information indicating the execution timing of a predetermined operation to the model training entity, and therefore the model training entity can simply perform the predetermined operation at that timing. Therefore, in the first embodiment, the number of times the model training history information is transmitted is reduced compared to when, for example, the model training entity transmits the model training history information every time it performs model training. Therefore, in the first embodiment, it is possible to enhance communication efficiency.

### (2.1) Configuration Example of Mobile Communication System 1 According to First Embodiment

A configuration example of the mobile communication system 1 according to the first embodiment will be described.

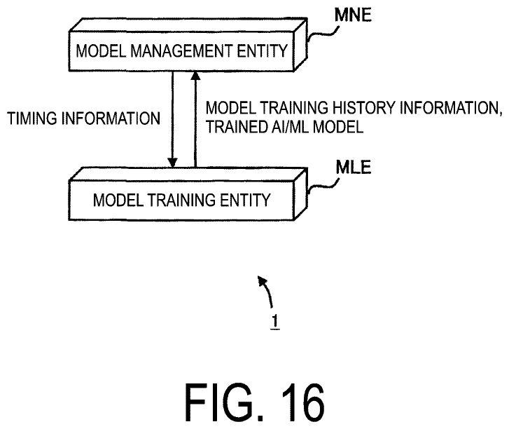

FIG. 16 is a diagram illustrating a configuration example of the mobile communication system 1 according to the first embodiment.

As illustrated in FIG. 16, the mobile communication system 1 includes a model management entity MNE and a model training entity MLE.

The model management entity MNE is, for example, an entity that manages the AI/ML model used in the mobile communication system 1. The model management entity MNE holds a model management list in a memory, and in the model management list, each AI/ML model is identified by a model ID. In the first embodiment, the model management entity MNE may assign a model ID (or model identification information; hereinafter, sometimes referred to as a “model ID”) to an AI/ML model.

The model ID may be any identification information that at least distinguishes the AI/ML model from other AI/ML models. The model ID may be a globally identifying information. That is, the model ID may be identification information that is unique among Public Land Mobile Networks (PLMNs). Therefore, the model ID may include a PLMN ID. Alternatively, the model ID may be identification information that is unique among Non-public networks (NPNs). Therefore, the model ID may include an NPN ID. The NPN ID may be a PLMN ID and a Closed Access Group ID (CAG), or a PLMN ID and a Network ID (NID). Alternatively, the model ID may include a global gNB ID that can globally identify the gNB 200. Alternatively, the model ID may include an NR Cell Global Identifier (NCGI) that can globally identify NR cells.

The model training entity MLE is, for example, an entity that performs model training on an AI/ML model. The AI/ML model to be trained may be a trained AI/ML model. The model may be an untrained AI/ML model. However, in the first embodiment, the model training entity MLE will be described as performing model training on a trained AI/ML model. Hereinafter, performing model training on a trained AI/ML model may be referred to as “re-training.” The model training entity MLE re-trains a trained AI/ML model, thereby deriving an AI/ML model that is different from the trained AI/ML model. This is because, when model inference is performed on the AI/ML model before re-training and the AI/ML model after re-training by re-training, it is assumed that different inference result data will be output. In the following, the AI/ML model before re-training may be referred to as a “trained model A” and the AI/ML model after re-training may be referred to as a “trained model A′”.

The model training entity MLE may perform model inference on a trained AI/ML model (which may be a trained model A or a trained model A′). In this case, the model training entity MLE functions as a transmission entity that transmits inference result data indicating the results of performing model inference.

In the first embodiment, whether re-training has been performed on the trained AI/ML model is managed using model change information.

First, the model change information is, for example, information indicating whether a trained AI/ML model has been re-trained (e.g., trained information). Alternatively, the model change information may be information indicating whether a trained AI/ML model has been changed by re-training the model. The model change information may be represented as one-bit flag information. Alternatively, the model change information may be represented by a plurality of bits and incremented each time re-training is performed. In the following, the model change information is described as one-bit flag information. In this case, the model change information being on indicates that re-training has been performed on the trained AI/ML model, and the model change information being off (or cleared) indicates that re-training has not been performed on the trained AI/ML model. However, on and off may have opposite meanings. The flag information may indicate a toggle state. For example, when the initial value of the flag information is off, it will be turned on at the first training, turned off again at the second training, and turned off again at the third training. Thereafter, each time training is performed, on and off is switched.

Second, the model change information may be included in a model ID identifying the AI/ML model. That is, the model change information may be added to a part of the model ID. Alternatively, the model change information may be included in the additional information (FIG. 15) included in the configuration message. Specifically, the model change information may be included in the individual additional information (Info) added to the corresponding AI/ML model. Alternatively, the model change information may be included in the AI/ML model. Specifically, the model change information may be included in the model body of the AI/ML model. The model change information may be included in the model data of the AI/ML model.

In the first embodiment, an example in which the model training entity MLE is the UE 100 and the model management entity MNE is the gNB 200 will be mainly described, but the present disclosure is not limited thereto. For example, the model management entity MNE may be a core network apparatus. The model management entity MNE may be an Over The Top (OTT) server apparatus. The OTT server apparatus is, for example, an apparatus that exists outside the mobile communication system 1 and provides various content services, such as video distribution, to the UE 100. Alternatively, the model training entity MLE may be the gNB 200, and the model management entity MNE may be a core network apparatus or an OTT server apparatus.

### (2.1) Operation Example According to First Embodiment

An operation example according to the first embodiment will be described.

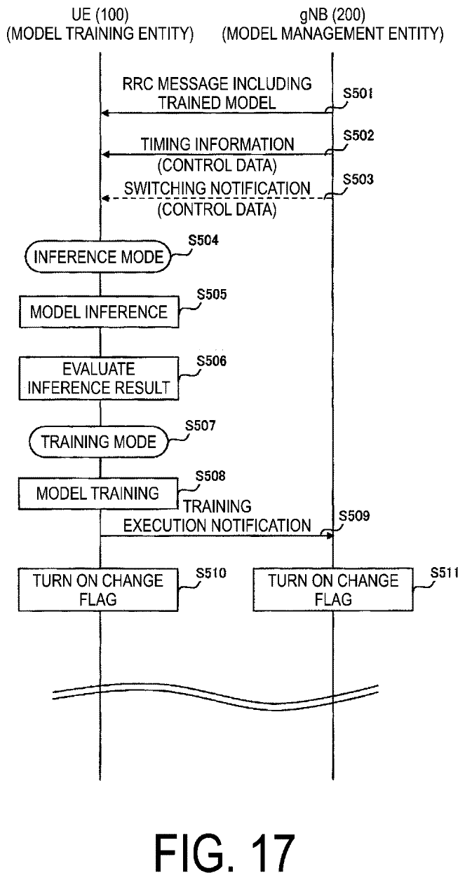

FIG. 17 illustrates an operation example according to the first embodiment. FIG. 17 illustrates an example in which the model training entity MLE is the UE 100 and the model management entity MNE is the gNB 200, as described above. In the UE 100, reception of messages and the like may be performed by the receiver 110 of the UE 100, and transmission of messages and the like may be performed by the transmitter 120. Processing or operations in the UE 100 may be performed by the controller 130, and processing or operations in the gNB 200 may be performed by the controller 230.

As illustrated in FIG. 17, in step S501, the gNB 200 transmits an RRC message including a trained AI/ML model (hereinafter described as a trained model A) to the UE 100. The gNB 200 may determine the trained model A to be transmitted based on an information element indicating the execution capability for machine learning processing received from the UE 100 (steps S402 and S403 of FIG. 14). The gNB 200 may transmit the model ID of the trained model A to the UE 100 along with the trained model A. In this case, the gNB 200 may include the model ID of the trained model A in the individual additional information (Info) and transmit the information (FIG. 15). The UE 100 receives the RRC message.

In step S502, the gNB 200 transmits timing information indicating the execution timing of a predetermined operation to the UE 100. The gNB 200 may transmit the timing information by transmitting control data including the timing information to the UE 100. The UE 100 receives the timing information.

The timing information may be represented by the elapsed time (e.g., after 24 hours) since the trained model A was updated by re-training the trained model A. The elapsed time may be designated by a timer value. The timer may start when the model re-training is performed, and its expiration may indicate the execution timing. Alternatively, the timing information may be represented by the time period after the update of the trained model A (e.g., the late-night time period). In this case, it represents that the execution timing is when the designated time period arrives after the update of the trained model A. Alternatively, the timing information may be represented as designating the number of times an update occurs (or a re-train occurs). For example, when the designated number of times is 10 as the timing information, this represents that the execution timing is when the trained model A has been updated 10 times. The number of updates may be measured by a counter. The counter may be reset to an initial value (e.g., zero) when a trained model is received, and may be incremented by one each time re-training is performed. Alternatively, the timing information may be designated by the operation after the update. For example, the operation includes handover, cell (re)selection, or redirection. In this case, the execution timing may be a timing when handover is performed, cell (re)selection is performed, or redirection is performed after updating the trained model A.

Examples of predetermined operations to be a target of timing information include the following.

First, the predetermined operation may be to transmit, to the gNB 200, model training history information indicating the history of model training performed on the trained model A. In this case, the UE 100 will transmit model training history information to the gNB 200 when the execution timing arrives.

Second, the predetermined operation may be to transmit the trained model A′ after model training to the gNB 200. In this case, when the execution timing arrives, the UE 100 will transmit the trained model A′ to the gNB 200.

Third, the predetermined operation may be to update the model ID that identifies the trained model A′. In this case, the UE 100 will update the model ID of the trained model A′ when the execution timing arrives.

In the first embodiment, such a predetermined operation is not performed every time the trained model A is re-trained, but is performed at the execution timing designated by the timing information.

Regarding the predetermined operation, for example, information indicating which predetermined operation it is may be included in the timing information.

In step S503, the gNB 200 transmits, to the UE 100, a switching notification for switching from the training mode to the inference mode. The switching notification may include the model ID of the trained model A (step S501). The UE 100 receives the switching notification.

In step S504, in response to receiving the switching notification, the UE 100 switches to the inference mode.

In step S505, the UE 100 performs model inference on the trained model A received in step S501.

In step S506, the UE 100 evaluates the inference result of the model inference (step S505).

First, the UE 100 may evaluate the inference results by comparison with a legacy operation. For example, during model inference, the UE 100 performs a legacy operation that does not use an AI/ML model, and acquires operation result data. Then, the UE 100 may compare the operation result data with inference result data based on the model inference, and evaluate the inference result. The UE 100 may determine that re-training of the trained model A is not necessary if a difference between the operation result data and the inference result data is within a threshold value, and the UE 100 may determine that re-training is necessary if not.

Second, the UE 100 may evaluate the inference result by performing a likelihood determination on the inference result data. Specifically, the UE 100 may apply a likelihood function to inference result data at a certain timing, compare it with inference result data immediately before that timing, and evaluate the inference result. For example, the UE 100 may determine that re-training of the trained model A is not necessary if a difference between the data to which the likelihood function has been applied and the inference result data is within a threshold value, and the UE 100 may determine that re-training is necessary if not.

In this way, the UE 100 determines whether re-training of the trained model A is necessary based on the inference result of model inference using the trained model A. In the following description, it is assumed that the UE 100 has determined that re-training of the trained model is necessary as a result of evaluating the inference result.

In step S507, the UE 100 switches to the training mode. The UE 100 may use control data to transmit, to the gNB 200, a notification indicating that the training mode will be switched.

In step S508, the UE 100 performs model training (i.e., re-training) on the trained model A.

In step S509, the UE 100 transmits, to the gNB 200, a training execution notification indicating that re-training of the trained model A has been performed. The UE 100 may transmit the training execution notification by transmitting an RRC message including the training execution notification. Alternatively, when a new layer is defined for performing or controlling machine learning processing (AI/ML processing), the UE 100 may transmit a training execution notification by including the training execution notification in a message of the new layer and transmitting the message. The gNB 200 receives the training execution notification.

In step S510, the UE 100 turns on the model change information of the trained model A. Alternatively, the UE 100 may turn on the model change information of the trained model A in response to receiving, from the gNB 200, configuration information (control data) indicating that the model change information is to be turned on. The UE 100 may transmit, to the model management entity MNE, a change flag-on notification indicating that the model change information has been turned on. The change flag-on notification may also be transmitted using an RRC message or a new message for machine learning processing (AI/ML processing).

In step S511, in response to receiving the training execution notification (step S509), the gNB 200 turns on the model change information of the trained model A. The gNB 200, which is a model management entity MNE, holds a model management list in a memory. The gNB 200 may register the trained model A by recording on in the model change information of the trained model A in the model management list.

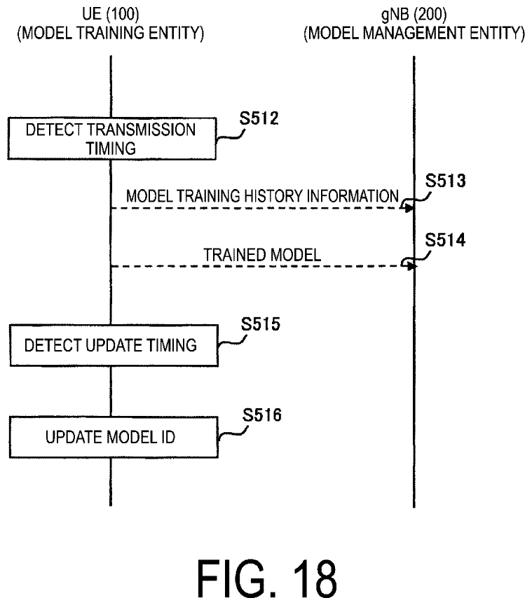

In step S512 of FIG. 18, the UE 100 detects that it is an execution timing of a predetermined operation.

First, the UE 100 may detect the transmission timing of the model training history information as the execution timing of the predetermined operation. The model training history information may include information about the history of model training. The model training history information includes, for example, the time when the model training was performed, or the training data (and/or the type of training data) used in the model training. The model training history information may include information about the history for each trained model. The target of the model training history information may be the trained model A before re-training.

Second, the UE 100 may detect the transmission timing (or the transfer timing) of the trained model A′ as the execution timing of the predetermined operation. In this case, it is assumed that the UE 100 has derived the trained model A′ at this point in time as a result of model training of the trained model A (step S508). Therefore, the transmission target can be the trained model A′.

In step S513, the UE 100 may transmit model training history information.

In step S514, the UE 100 may transmit the trained model A′. Both the model training history information and the trained model A′ may be transmitted using an RRC message or a new message for machine learning processing (AI/ML processing).

In step S515, the UE 100 detects the update timing of the model ID as the execution timing of the predetermined operation.

First, the UE 100 may be configured to execute acquisition processing of a model ID for the trained model A′ by using the detection of update timing as a trigger. As the acquisition processing of a model ID, the UE 100 may transmit an acquisition request of a model ID to the gNB 200. The acquisition request may include the model ID of the trained model A before re-training. Alternatively, the acquisition request may include model change information (step S510). The acquisition request may be transmitted using an RRC message or a new message for machine learning processing (AI/ML processing). In response to receiving the acquisition request, the gNB 200 assigns a new model ID and transmits the new model ID to the UE 100. The new model ID may be transmitted using the control data.

Second, the acquisition processing of the model ID may itself be performed before step S512. For example, the acquisition request may be transmitted at the timing when the UE 100 re-trains the trained model A (step S508). The training execution notification (step S509) may also serve as (or imply) the acquisition request. In response to receiving the acquisition request, the gNB 200 assigns a new model ID and transmits the new model ID to the UE 100. The UE 100 may update the model ID by holding the new model ID acquired from the model management entity MNE in a memory and applying the new model ID to the trained model A′ when the update timing is detected (step S515).

### Another Operation Example 1 According to First Embodiment

In the first embodiment, an example in which the model management entity MNE is the gNB 200 has been described, but the model management entity MNE is not limited to the gNB 200. The model management entity MNE may be a core network apparatus.

In this case, in the operation examples illustrated in FIGS. 17 and 18, this can be implemented by replacing the gNB 200 with a core network apparatus. At this time, between the UE 100 (model training entity MLE) and the core network apparatus (model management entity MNE), steps S501, S502, S503, S509, S513, and S514, and the like may be performed using a message available between the UE 100 and the core network apparatus (e.g., a NAS message when the core network apparatus is the AMF 300).

### Another Operation Example 2 According to First Embodiment

The model management entity MNE may be an OTT server apparatus. In this case, in the operation examples illustrated in FIGS. 17 and 18, this can be implemented by replacing the gNB 200 with an OTT server apparatus. At this time, between the UE 100 (model training entity MLE) and the OTT server apparatus (model management entity MNE), steps S501, S502, S503, S509, S513, and S514, and the like may be performed using a message available between the UE 100 and the OTT server apparatus.

### Another Operation Example 3 According to First Embodiment

In the first embodiment, the example in which the model training entity MLE is the UE 100 has been described, but the model training entity MLE is not limited to the UE 100. For example, the model training entity MLE may be the gNB 200. In this case, the model management entity MNE may be a core network apparatus. The model management entity MNE may be an OTT server apparatus.

When the model training entity MLE is the gNB 200 and the model management entity MNE is a core network apparatus, in the operation examples illustrated in FIGS. 17 and 18, this can be implemented by replacing the UE 100 (model training entity) with the gNB and the gNB 200 (model management entity) with a core network apparatus. In this case, between the gNB 200 (model training entity) and the core network apparatus (model management entity), steps S501, S502, S503, S509, S513, and S514, and the like may be performed using a message available between these apparatuses (e.g., an NG message).

When the model training entity MLE is the gNB 200 and the model management entity MNE is an OTT server apparatus, in the operation example illustrated in FIG. 17, this can be implemented by replacing the UE 100 (model training entity) with the gNB 200 and the gNB 200 (model management entity) with an OTT server apparatus. In this case, between the gNB 200 (model training entity) and the OTT server apparatus (model management entity), steps S501, S502, S503, S509, S513, and S514, and the like may be performed using a message available between these apparatuses.

### Second Embodiment

A second embodiment will be described. In the second embodiment, differences from the first embodiment will mainly be described.

In the first embodiment, an example has been described in which the UE 100 (model training entity MLE) evaluates the result of model inference, and the UE 100 itself determines whether to re-train the trained model A. In the second embodiment, an example will be described in which UE 100 performs re-training of the trained model A in accordance with a re-training instruction from the model management entity MNE.

### Operation Example According to Second Embodiment

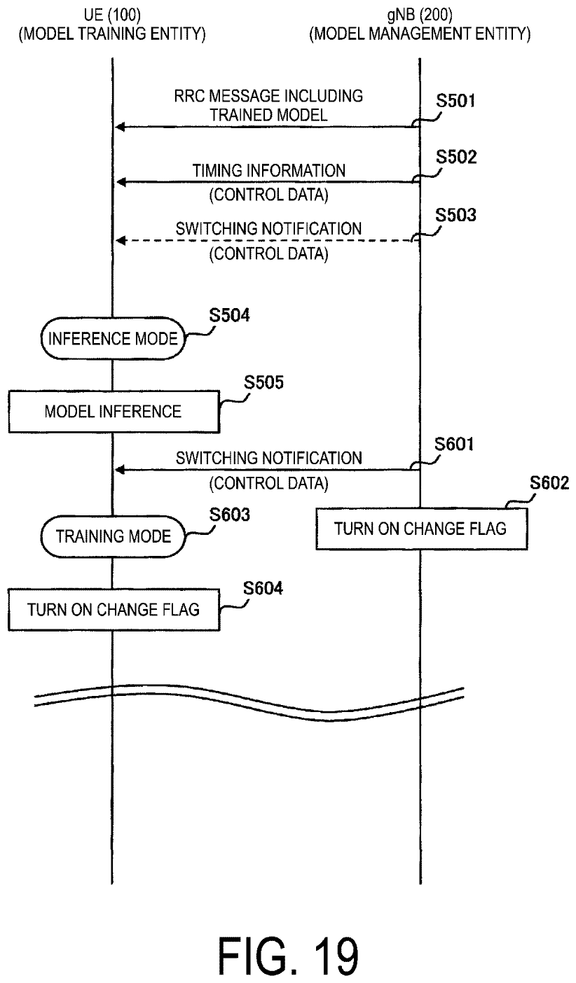

FIG. 19 is a diagram illustrating an operation example according to the second embodiment. FIG. 19 illustrates an example in which the model training entity MLE is the UE 100 and the model management entity MNE is the gNB 200. In FIG. 19, in the UE 100, reception of messages and the like may be performed by the receiver 110 of the UE 100, and transmission of messages and the like may be performed by the transmitter 120. In FIG. 19, processing or operations in the UE 100 may be performed by the controller 130, and processing or operations in the gNB 200 may be performed by the controller 230.

As illustrated in FIG. 19, steps S501 to S505 are the same operations as those in the first embodiment.

In step S601, the gNB 200 transmits, to the UE 100, a switching notification for switching from the inference mode to the training mode. The switching notification may be a switching notification for starting re-training for the trained model A transmitted in step S501. The switching notification may include the model ID of the trained model A to be switched. The UE 100 receives the switching notification.

In step S602, in response to transmitting the switching notification (step S601), the gNB 200 turns on the model change information of the trained model A.

In step S603, in response to receiving the switching notification, the UE 100 switches to the inference mode.

In step S604, the UE 100 turns on the model change information. The UE 100 may transmit, to the model management entity MNE, a change flag-on notification indicating that the model change information has been turned on. The change flag-on notification may also be transmitted using an RRC message or a new message for machine learning processing (AI/ML processing)

Thereafter, steps S512 to S516 in FIG. 18 are executed in the same manner as in the first embodiment.

### Another Operation Example 1 According to Second Embodiment

In the second embodiment, an example in which the model management entity MNE is the gNB 200 has been described, but the model management entity MNE may also be a core network apparatus.

In this case, in the operation example illustrated in FIG. 19, this can be implemented by replacing the gNB 200 (model management entity MNE) with a core network apparatus. At this time, between the UE 100 (model training entity MLE) and the core network apparatus (model management entity MNE), step S601 and the like may be performed using a message available between the UE 100 and the core network apparatus (e.g., a NAS message when the core network apparatus is the AMF 300).

### Another Operation Example 2 According to Second Embodiment

The model management entity MNE may be an OTT server apparatus. In this case, in the operation example illustrated in FIG. 19, this can be implemented by replacing the gNB 200 (model management entity MNE) with an OTT server apparatus. At this time, between the UE 100 (model training entity MLE) and the OTT server apparatus (model management entity MNE), step S601 and the like may be performed using a message available between the UE 100 and the OTT server apparatus.

### Another Operation Example 3 According to Second Embodiment

In the second embodiment, the example in which the model training entity MLE is the UE 100 has been described, but the model training entity MLE is not limited to the UE 100. For example, the model training entity MLE may be the gNB 200. In this case, the model management entity MNE may be a core network apparatus. The model management entity MNE may be an OTT server apparatus.

When the model training entity MLE is the gNB 200 and the model management entity MNE is a core network apparatus, in the operation example illustrated in FIG. 19, this can be implemented by replacing the UE 100 (model training entity) with the gNB 200 and the gNB 200 (model management entity) with a core network apparatus. In this case, between the gNB 200 and the core network apparatus, step 601 and the like may be performed using a message available between these apparatuses (e.g., an NG message).

When the model training entity MLE is the gNB 200 and the model management entity MNE is an OTT server apparatus, in the operation example illustrated in FIG. 17, this can be implemented by replacing the UE 100 (model training entity) with the gNB 200 and the gNB 200 (model management entity) with an OTT server apparatus. In this case, between the gNB 200 and the OTT server apparatus, step 601 and the like may be performed using a message available between these apparatuses.

### Third Embodiment

A third embodiment will be described. In the third embodiment, differences from the first and second embodiments will mainly be described.

In the first embodiment, an example has been described in which the model training entity MLE evaluates the inference result and re-trains the trained model. In the second embodiment, an example has been described in which the model training entity MLE receives a re-training instruction from the model management entity MNE and re-trains the trained model.

In the third embodiment, an example will be described in which the model management entity MNE evaluates the inference results of the model inference performed by the model training entity MLE and causes the model training entity MLE to re-train the trained model.

### Operation Example According to Third Embodiment

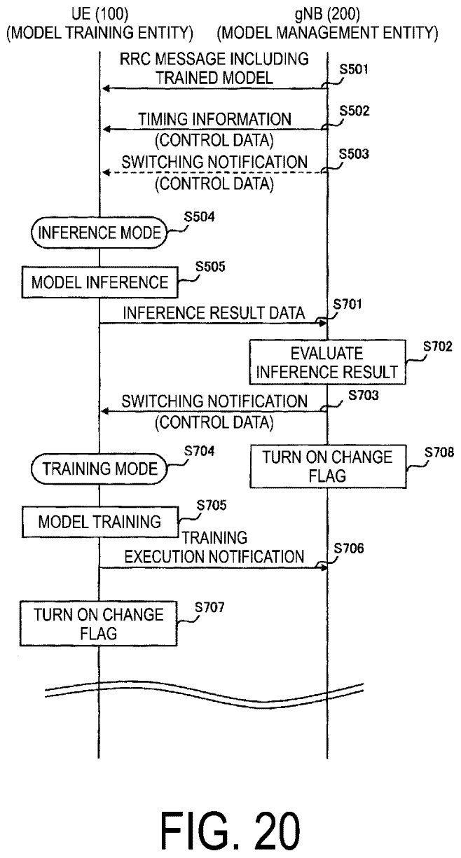

FIG. 20 is a diagram illustrating an operation example according to the third embodiment. FIG. 20 also illustrates an example in which the model training entity MLE is the UE 100 and the model management entity MNE is the gNB 200. In FIG. 20, in the UE 100, reception of messages and the like may be performed by the receiver 110 of the UE 100, and transmission of messages and the like may be performed by the transmitter 120. In FIG. 20, processing or operations in the UE 100 may be performed by the controller 130, and processing or operations in the gNB 200 may be performed by the controller 230.

Steps S501 to S505 are the same as those in the first embodiment.

In step S701, the UE 100 transmits the inference result data for the trained model A received in step S501 to the gNB 200. The inference result data may also be transmitted using an RRC message or a new message for machine learning processing (AI/ML processing).

In step S702, the gNB 200 evaluates the inference result. The method for evaluating the inference result itself may be the same as that in the first embodiment (step S506 in FIG. 17). When the gNB 200 evaluates the inference result by comparison with a legacy operation, the gNB 200 may compare the inference result with operation result data from a legacy operation received from other UEs under the same conditions as the UE 100 (or at the same timing as the inference). In the following description, it is assumed that the gNB 200 has determined that re-training of the trained model A is necessary as a result of the evaluation.

In step S703, the gNB 200 transmits, to the UE 100, a switching notification for switching from the inference mode to the training mode.

In response to receiving the switching notification, the UE 100 switches to training mode (step S704), performs model training (i.e., re-training) for the trained model A (step S705), and transmits a training execution notification to the gNB 200 (step S706).

Then, in step S707, the UE 100 turns on the model change information for the trained model A.

Meanwhile, in step S708, the gNB 200 turns on the model change information of the trained model A in response to transmitting the switching notification (step S703).

Thereafter, steps S512 to S516 in FIG. 18 are executed in the same manner as in the first embodiment.

### Another Operation Example 1 According to Third Embodiment

In the third embodiment, an example in which the model management entity MNE is the gNB 200 has been described, but the model management entity MNE may also be a core network apparatus.

In this case, in the operation example illustrated in FIG. 20, this can be implemented by replacing the gNB 200 (model management entity MNE) with a core network apparatus. At this time, between the UE 100 (model training entity MLE) and the core network apparatus (model management entity MNE), steps S701 and S703 and the like may be performed using a message available between the UE 100 and the core network apparatus (e.g., a NAS message when the core network apparatus is the AMF 300).

### Another Example 2 According to Third Embodiment

The model management entity MNE may be an OTT server apparatus. In this case, in the operation example illustrated in FIG. 20, this can be implemented by replacing the gNB 200 (model management entity MNE) with an OTT server apparatus. At this time, between the UE 100 (model training entity MLE) and the OTT server apparatus (model management entity MNE), step S701 and S703 and the like may be performed using a message available between the UE 100 and the OTT server apparatus.

### Another Operation Example 3 According to Third Embodiment

In the third embodiment, the example in which the model training entity MLE is the UE 100 has been described, but the model training entity MLE is not limited to the UE 100. For example, the model training entity MLE may be the gNB 200. In this case, the model management entity MNE may be a core network apparatus. The model management entity MNE may be an OTT server apparatus.

When the model training entity MLE is the gNB 200 and the model management entity MNE is a core network apparatus, in the operation example illustrated in FIG. 20, this can be implemented by replacing the UE 100 (model training entity) with the gNB 200 and the gNB 200 (model management entity) with a core network apparatus. In this case, between the gNB 200 and the core network apparatus, steps S701 and S703 and the like may be performed using a message available between these apparatuses (e.g., an NG message).

When the model training entity MLE is the gNB 200 and the model management entity MNE is n OTT server apparatus, in the operation example illustrated in FIG. 20, this can be implemented by replacing the UE 100 (model training entity) with the gNB 200 and the gNB 200 (model management entity) with an OTT server apparatus. In this case, between the gNB 200 and the OTT server apparatus, steps S701 and S703 and the like may be performed using a message available between these apparatuses.

### OTHER EMBODIMENTS

In the above-described first to third embodiments, the trained AI/ML model has been described as the target of timing information, but the present disclosure is not limited thereto. For example, the target of the timing information may be an untrained AI/ML model. In this case, for example, in the operation example of FIG. 17, steps S504 to S506 are not performed (model inference is not performed for untrained AI/ML models), and model training is performed in training mode in the UE 100 (steps S507 and S508). Thereafter, the operation examples illustrated in FIGS. 17 and 18 are implemented. The same applies to FIGS. 18 and 19.

In the first to third embodiments described above, the supervised learning has mainly been described. However, the present disclosure is not limited thereto. For example, unsupervised learning or reinforcement learning may be applied to the first to third embodiments.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program (e.g., information processing program) may be provided that causes a computer to execute each of the processing operations or each of the functions according to the embodiments described above. A program (e.g., mobile communication program) may be provided that causes the mobile communication system 1 to execute each of the processing operations or each of the functions according to the embodiments described above. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise”, and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure. It is also possible to combine each embodiment, each operation example, each process, and the like without contradicting.

### Supplementary Notes

### (Supplementary Note 1)

A communication control method in a mobile communication system (e.g., the mobile communication system 1), the communication control method including the steps of: transmitting, by a model management entity (e.g., the gNB 200), timing information indicating an execution timing of a predetermined operation to a model training entity (e.g., the UE 100); and
executing, by the model training entity, the predetermined operation at the execution timing, in which the predetermined operation is at least one selected from the group consisting of transmitting model training history information indicating a history of model training performed on a first AI/ML model to the model management entity, transmitting a second AI/ML model after model training has been performed on the first AI/ML model to the model management entity, and updating model identification information identifying the second AI/ML model.

### (Supplementary Note 2)

The communication control method according to Supplement 1, in which the first AI/ML model is a trained AI/ML model.

### (Supplementary Note 3)

The communication control method according to Supplement 1 or 2, further including:
turning on, by the model training entity, model change information indicating whether the model training has been performed, when model training has been performed on the first AI/ML model.

### (Supplementary Note 4)

The communication control method according to any one of Supplements 1 to 3, in which the model training entity is a user equipment, and the model management entity is any one of a network node, a core network apparatus, or an Over The Top (OTT) server apparatus.

### (Supplementary Note 5)

A user equipment (e.g., the UE 100) including:
a receiver (e.g., the receiver 110) configured to receive timing information transmitted from a model management entity (e.g., the gNB 200) and indicating an execution timing of a predetermined operation; and
a controller (e.g., the controller 130) configured to execute the predetermined operation at the execution timing,
in which the predetermined operation is at least one selected from the group consisting of transmitting model training history information indicating a history of model training performed on a first AI/ML model to the model management entity, transmitting a second AI/ML model after model training has been performed on the first AI/ML model to the model management entity, and updating model identification information identifying the second AI/ML model.

### REFERENCE SIGNS

1: Mobile communication system
20: 5GC (CN)
100: UE
110: Receiver
120: Transmitter
130: Controller
200: gNB
210: Transmitter
220: Receiver
230: Controller
A1: Data collector
A2: Model trainer
A3: Model inferrer
A4: Data processor
TE: Transmission entity
RE: Reception entity
MLE: Model training entity
MNE: Model management entity

1. A communication control method in a mobile communication system, the communication control method comprising the steps of:
transmitting, by a model management entity, timing information indicating an execution timing of a predetermined operation to a model training entity; and
executing, by the model training entity, the predetermined operation at the execution timing,
wherein the predetermined operation is at least one selected from the group consisting of transmitting model training history information indicating a history of model training performed on a first artificial intelligence (AI)/machine learning (ML) model to the model management entity, transmitting a second AI/ML model after model training has been performed on the first AI/ML model to the model management entity, and updating model identification information identifying the second AI/ML model.

2. The communication control method according to claim 1, wherein the first AI/ML model is a trained AI/ML model.

3. The communication control method according to claim 1, further comprising:
turning on, by the model training entity, model change information indicating whether the model training has been performed, when model training has been performed on the first AI/ML model.

4. The communication control method according to claim 1, wherein
the model training entity is a user equipment, and
the model management entity is any one of a network node, a core network apparatus, or an Over The Top (OTT) server apparatus.

5. A user equipment comprising:
a receiver configured to receive timing information transmitted from a model management entity and indicating an execution timing of a predetermined operation; and
a controller configured to execute the predetermined operation at the execution timing,
wherein the predetermined operation is at least one selected from the group consisting of transmitting model training history information indicating a history of model training performed on a first AI/ML model to the model management entity, transmitting a second AI/ML model after model training has been performed on the first AI/ML model to the model management entity, and updating model identification information identifying the second AI/ML model.
